(19) United States
(12) Patent Application Publication
(10) Pub. No.: US 2019/0388856 A1
(43) Pub. Date: Dec. 26, 2019

(54) VACUUM DUST EXTRACTOR

(71) Applicant: DUST-A-SIDE INTERNATIONAL (PTY) LTD, Centurion (ZA)

(72) Inventor: Werner Rudolph DE KOCK, Centurion (ZA)

(21) Appl. No.: 16/449,638

(22) Filed: Jun. 24, 2019

(30) Foreign Application Priority Data
Jun. 25, 2018 (ZA) 2018/04237

(51) Int. Cl. B01F 15/00; B01F 15/02; B01F 3/12; B01F 9/06; B01D 46/04; B01D 46/44; B01D 46/00

(52) U.S. Cl. CPC B01F 15/00974; B01F 15/0243; B01F 3/1271; B01F 9/06; B01D 2279/35; B01D 46/04; B01D 46/446; B01D 46/002; B01F 15/00201

(57) ABSTRACT

This invention relates to a particle extractor assembly 10, 100 which is used to extract and collect dust and/or other airborne pollutants from a workface. The assembly 100 is mobile as is mounted to a base 12 which includes a first platform 12.1 and a second pivotal platform 12.2 which is articulated to the first platform 12.1 and is configured to be pivotally displaced relative to the first platform between a lowered position and a discharge position in which it is inclined with respect to the first platform 12.1. The assembly also includes a vacuum pump 150 powered by an electrical motor 160, a particle filter 200 to filter out particles upstream of the vacuum pump and a drum arrangement which includes a collector drum 170 configured to rotate about an axis to mix its contents to form a slurry and it discharge the contents when in the discharge position.

### CROSS-REFERENCE TO RELATED APPLICATIONS

This application claims the benefit of South Africa Provisional Patent Application No. 2018/04237 filed 25 Jun. 2018, the entire disclosure of which is incorporated herein by reference.

### FIELD OF INVENTION

This invention relates to dust control or suppression in general. More specifically, it relates to an industrial particle extractor or collector and to a method of collecting, treating and discarding dust particles.

### BACKGROUND OF INVENTION

Extraction systems which remove airborne or entrained particles from industrial workplaces have been in use for a number of years. However, some of these existing extraction systems simply extract and exhaust pollutants to atmosphere instead of removing them altogether. An effective way to deal with airborne hazards is to remove them at source, before they are dispersed throughout the workplace and, potentially, the external atmosphere.

This is especially true in the mining sector where accumulation and disruption of dust and other harmful airborne particles may cause serious environmental and health problems including pollution, contamination and respiratory disease. Instead of venting harmful pollutants to atmosphere, it is more advantageous to remove such particles from the air thereby preserving the environment and protecting employees from the potential health hazards associated with breathing in polluted air. Conventional vacuum extraction units, which may be configured to collect air pollutants at source, are plagued by poor pollutant handling procedures which often leads to collected air pollutants being reintroduced into atmosphere upon emptying of these vacuum extraction units.

The Applicant has identified a need for an industrial dust extractor or collector which addresses or at least alleviates the drawbacks referred to above.

### SUMMARY OF INVENTION

According to a first aspect of the invention, there is provided a particle extractor assembly which includes:
a base;
a vacuum pump mounted to the base;
a powerplant mounted to the base, the powerplant being drivingly connected to the vacuum pump;
a particle filter arranged upstream of the vacuum pump in order to filter out particles upstream of the vacuum pump; and
a collector drum having an inlet for drawing particles into an inner cavity of the drum and an outlet leading to the vacuum pump, wherein the vacuum pump is configured to create suction through the assembly to draw particles into the collector drum via the inlet, the collector drum being configured to rotate relative to the base about a rotation axis in order to mix contents of the drum and to discharge the contents of the drum.

The particle extractor assembly may include a tank for holding an additive. The additive may be for admixture with the contents of the collector drum to create a slurry or paste. The additive may be a chemical additive. The additive may be a polymeric additive. To this end, the assembly may include an additive delivery system which is configured to introduce additive from the tank into the inner cavity of the collector drum. The additive delivery system may include a delivery pump which is configured to pump additive from the tank to the inner cavity of the collector drum.

The powerplant may be an electrical motor. The powerplant may be directly coupled to the vacuum pump by way of a flexible coupling. Alternatively, the powerplant may be a combustion engine.

The particle extractor assembly may include a drum arrangement which includes:
the collector drum;
a drum mounting which is operatively connected to the base and is configured to receive the collector drum; and
a drum drive drivingly connected to the collector drum and configured to rotate the collector drum relative to the drum mounting and about its rotation axis.

The drum drive may be configured to rotate the collector drum about its rotation axis in one of two possible directions.

The drum mounting may include a pair of cradles or braces which extend at least partially around a periphery of the collector drum and are configured to receive the drum. The cradles may include rollers which facilitate rotation of the collector drum relative to the cradles. The cradles may be interconnected by way of peripherally spaced apart, elongate braces. The collector drum may include a convexly curved, downstream portion toward the outlet, a cylindrical portion connected to the convexly curved portion, and a frusto-conical portion which is connected to the cylindrical portion and tapers to the operative upstream inlet of the drum. The collector drum may include a removable lid which is configured to close the inlet, at least in part. The collector drum may be substantially horizontally orientated. In other words, the inlet and outlet may be coaxially aligned and may lie within a horizontal plane.

The assembly may include a silencer or muffler which is operatively in fluid flow communication with the vacuum pump, downstream of the vacuum pump and configured to lower emission sounds of the assembly to equal to, or below 80 dB.

The assembly may include an electrical control panel which provides an operator interface for controlling the assembly. The assembly may include one or more load sensors. To this end, the assembly may include an electronic control unit. The load sensors may be coupled to or communicatively linked to the control unit. The electronic control unit may be configured to interrupt operation of the vacuum pump if the load sensors indicate that the collector drum is overloaded. The control panel may include a load indicator which indicators an overload condition to the operator. The assembly may include an emergency stop to turn off power to the vacuum pump.

The assembly may be configured for use in underground mining operations. Accordingly, the assembly may be intrinsically safe or otherwise electrically safe for underground mining operations. The assembly may include protective panels or guards, mounted to the base, which guard, by at least partially enclosing, the components of the assembly.

The particle filter may be arranged in fluid flow communication between the collector drum and the vacuum pump, i.e. downstream of the collector drum and upstream of the vacuum pump. The particle filter may include a plurality of filter bags or socks housed within a filter housing. The filter housing may have a downwardly orientated inspection opening which is operatively closed by an inspection lid.

The collector drum may be configured to mix contents of the drum when the collector drum is rotated relative to the base in a first direction. Furthermore, the collector drum may be configured to discharge or expel its contents from the inner cavity via the inlet when rotated about its rotation axis in a second direction. To this end, the collector drum may include a plurality of internal vanes which are arranged to assist discharging of the contents from the drum when rotated in the second direction.

The assembly may include a pressurised air supply, i.e. a compressor which is configured to clean the filter bags of the particle filter, intermittently, by pulsating air through the filter bags. The filter bags may be cleaned, in situ, by way of air pulses.

The method of cleaning is referred to as pulse jet cleaning. The particle extractor assembly may include a pair of pressure sensors configured to measure a pressure differential across the particle filter in order to determine when the particle filter needs to be cleaned/emptied or otherwise maintained. The pressure sensors may be arranged across an inlet and outlet of the particle filter.

The particle extractor assembly may be mobile or portable. The assembly may be transportable by a dedicated mining vehicle.

The invention extends to a method of collecting dust and/or other airborne particles using a particle extractor assembly as described above, the method including:
collecting airborne particles in the collector drum of the particle extractor assembly by operating the vacuum pump to create suction through the assembly;
treating contents of the drum using an additive by delivering the additive to the collector drum to form a slurry or paste; and
discharging the contents from the collector drum.

The collecting step may include, intermittently cleaning the particle filter by pulsating filter bags of the particle filter with pressurised air. The collecting step may include sensing, using a least two pressure sensors, a pressure differential across the particle filter in order to determine when the particle filter needs to be cleaned.

The step of treating may include rotating the collector drum relative to the base of the particle extractor assembly in a first direction in order to mix the contents. The treating step may further include actively introducing the additive to the collector drum.

The method may include the step of, prior to treating the contents of the drum, sensing, using one or more load sensors, when the collector drum is full and automatically turning off the pump.

The discharging step may include rotating the collector drum relative to the base in a second direction opposite to the first direction.

The method may include intermittently cleaning the particle filter of the assembly by pulsating filter elements of the particle filter with air.

In accordance with another aspect of the invention, there is provided a particle extractor assembly which includes:
a base;
a vacuum pump mounted to the base;
a powerplant mounted to the base, the powerplant being drivingly connected to the vacuum pump;
a particle filter arranged upstream of the vacuum pump in order to filter out particles upstream of the vacuum pump;
a drum arrangement which includes:
   a collector drum having an inlet for drawing particles into an inner cavity of the collector drum and an outlet leading to the particle filter;
   a drum mounting which is operatively connected to the base and is configured to receive the collector drum; and
   a drum drive drivingly connected to the collector drum and configured to rotate the collector drum relative to the drum mounting about a rotation axis; and
an additive delivery system which is mounted to the base and which includes a tank for holding an additive, the additive delivery system being configured to introduce additive from the tank into the inner cavity of the collector drum, wherein the vacuum pump is configured to create suction through the particle extractor assembly to draw particles into the collector drum via the inlet, the collector drum being configured, upon rotation of the collector drum about its rotation axis, to mix the additive introduced into the inner cavity by the additive delivery system with the particles in the inner cavity of the collector drum to form a slurry.

The particle extractor assembly may be configured, upon rotation of the collector drum about its rotation axis, to discharge the slurry from the inner cavity of the collector drum.

The base may include a first platform and a pivot platform, the pivot platform being articulated to the first platform. The particle extractor assembly may include an actuator operatively connected between the first platform and the pivot platform. The actuator may be configured pivotally to displace the pivot platform relative to the first platform about a pivot axis which is transverse to the rotation axis of the collector drum between a lowered position in which the pivot platform abuts the first platform and is coplanar therewith and a discharge position in which the pivot platform is inclined with respect to the first platform.

The drum arrangement and the particle filter may be mounted to the pivot platform and may be configured for pivotal displacement therewith about the pivot axis. The actuator may include a hydraulic pump which is mounted to the first platform and a hydraulic cylinder which is connected between the first platform and the pivot platform, the hydraulic pump being configured to actuate the hydraulic cylinder to displace the pivot platform between its lowered and discharge positions.

When the pivot platform is in its discharge position, an operatively downstream end of the collector drum defining the outlet may be raised with respect to the inlet of the collector drum to facilitate discharge of the slurry held in the inner cavity of the collector drum from the collector drum via the inlet.

The drum drive may be configured to rotate the collector drum about its rotation axis in opposite, first and second directions, wherein, when the collector drum is rotated relative to the base in the first direction, the collector drum is configured to mix contents of the collector drum, and, when rotated about its rotation axis in the second direction, the collector drum is configured to discharge or expel its contents from the inner cavity via the inlet. The collector drum may include a plurality of internal vanes which are arranged to assist discharging of the contents from the collector drum when rotated in the second direction.

The particle filter may be arranged downstream of the collector drum and upstream of the vacuum pump. The particle filter may include a plurality of filter bags which are housed within a filter housing at a higher elevation than the outlet of the collector drum. The filter housing may include a downwardly depending hopper which is connected in fluid flow communication to the outlet of the collector drum.

The particle extractor assembly may include a pressurised air supply which is configured to clean the filter bags of the particle filter, intermittently, by pulsating air through the filter bags, in reverse, thus serving to dislodge particles potentially clogging the filter bags and ejecting the dislodged particles back into the collector drum via the hopper arranged below the filter bags.

The particle extractor assembly may include a pair of pressure sensors arranged across an inlet and outlet of the particle filter and configured to measure a pressure differential across the particle filter in order to determine when the particle filter needs to be cleaned.

The pressurised air supply may include a compressor having a primary/master pressure vessel and a downstream secondary/slave pressure vessel which is connected to nozzles configured to pulsate air through the filter bags. The primary and secondary pressure vessels may be in fluid flow communication.

The additive delivery system may include a delivery pump which is configured to pump additive from the tank to the inner cavity of the collector drum.

The drum mounting may include a pair of cradles which extend at least partially around a periphery of the collector drum and are configured to receive the drum, the cradles including rollers which facilitate rotation of the collector drum relative to the cradles. The collector drum may include a downstream portion toward the outlet, a cylindrical portion connected to the downstream portion, and a frusto-conical portion which is connected to the cylindrical portion. The frusto-conical portion may taper to the operative upstream inlet of the collector drum. The collector drum may include a removable lid which is configured to close the inlet, at least in part. An inner surface of the collector drum may have a non-stick coating.

The particle extractor assembly may include a silencer which is operatively in fluid flow communication with the vacuum pump, downstream of the vacuum pump and is configured to lower emission sounds of the particle extractor assembly to equal to, or below 80 dB, an exhaust of the particle extractor assembly being operatively upwardly orientated.

The particle extractor assembly may include an electrical control panel and an electronic control unit which provide an operator interface for controlling the particle extractor assembly, and one or more load sensors which are coupled to or communicatively linked to the electronic control unit, wherein the electronic control unit is configured to interrupt operation of the vacuum pump if the load sensors indicate that the collector drum is overloaded. The electrical control panel includes a load indicator which is configured to indicator an overload condition to an operator.

The particle extractor assembly may further include protective panels, mounted to the base, which guard, by at least partially enclosing the assembly, an operator from components of the particle extractor assembly. The particle extractor assembly may be portable.

The invention extends to a method of collecting dust and/or other airborne particles using a particle extractor assembly as described above, the method including:
collecting airborne particles in the collector drum of the particle extractor assembly by operating the vacuum pump to create suction through the particle extractor assembly;
treating contents of the collector drum using an additive by delivering the additive to the collector drum to form a slurry; and
discharging the contents from the collector drum.

Collecting may include intermittently cleaning the particle filter by pulsating filter bags of the particle filter with pressurised air.

Collecting may include sensing, using a least two pressure sensors, a pressure differential across the particle filter in order to determine when the particle filter needs to be cleaned.

Treating may include rotating the collector drum relative to the base of the particle extractor assembly in a first direction in order to mix the contents.

Discharging may include rotating the collector drum relative to the base in a second direction opposite to the first direction and pivotally displacing a pivotal platform of the base to a discharge position in which it is inclined with respect to a remainder of the base.

### BRIEF DESCRIPTION OF DRAWINGS

The invention will now be further described, by way of example, with reference to the accompanying drawings.

In the drawings:

FIG. 1 illustrates a three-dimensional view of a first embodiment of a particle extractor assembly in accordance with the invention, where protective panels or guards have been omitted for the sake of clarity;

FIG. 2 illustrates another three-dimensional view of the particle extractor assembly, from an opposite side;

FIG. 3 shows a side elevation of the particle extractor assembly of FIG. 1;

FIG. 4 shows a front-end view of the particle extractor assembly;

FIG. 5 shows a plan view of a base of the particle extractor assembly;

FIG. 6 shows a three-dimensional view of a second embodiment of the particle extractor assembly in accordance with the invention;

FIG. 7 shows a plan view of the particle extractor assembly of FIG. 6;

FIG. 8 shows a three-dimensional view of the particle extractor assembly from a rear;

FIG. 9 shows a right side view;

FIG. 10 shows a front three-dimensional view of the particle extractor assembly of FIG. 6, absent protective panels for the sake of clarity;

FIG. 11 shows a right side view of the particle extractor assembly of FIG. 10;

FIG. 12 shows a top view of the particle extractor assembly of FIG. 10;

FIG. 13 shows a left side view;

FIG. 14 shows an enlarged or detailed view of part of the particle extractor assembly shown in FIG. 13;

FIG. 15 shows another detailed view from a different angle; and

FIG. 16 shows a right side view of the particle extractor assembly of FIG. 9 in a discharge position.

### DETAILED DESCRIPTION OF AN EXAMPLE EMBODIMENT

The following description of the invention is provided as an enabling teaching of the invention. Those skilled in the relevant art will recognise that many changes can be made to the embodiments described, while still attaining the beneficial results of the present invention. It will also be apparent that some of the desired benefits of the present invention can be attained by selecting some of the features of the present invention without utilising other features. Accordingly, those skilled in the art will recognise that modifications and adaptations to the present invention are possible and can even be desirable in certain circumstances, and are a part of the present invention. Thus, the following description is provided as illustrative of the principles of the present invention and not a limitation thereof.

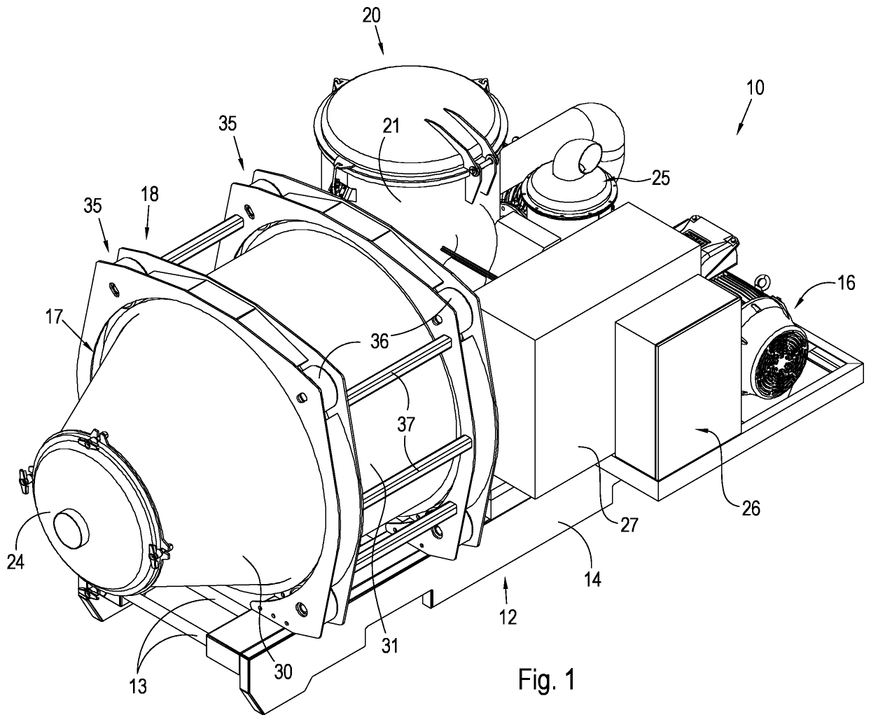

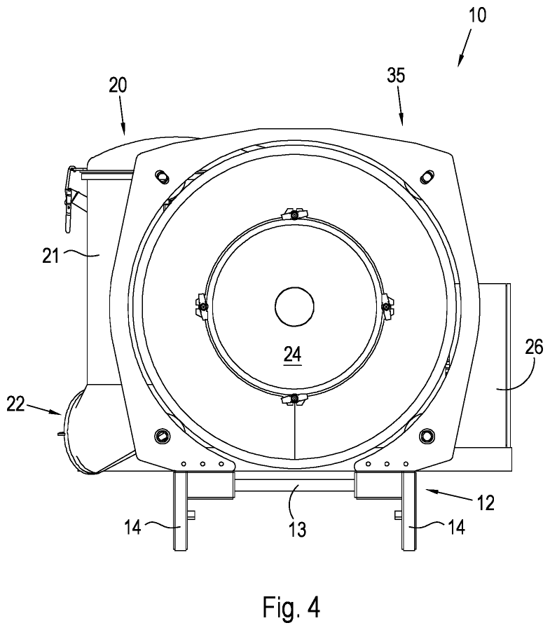

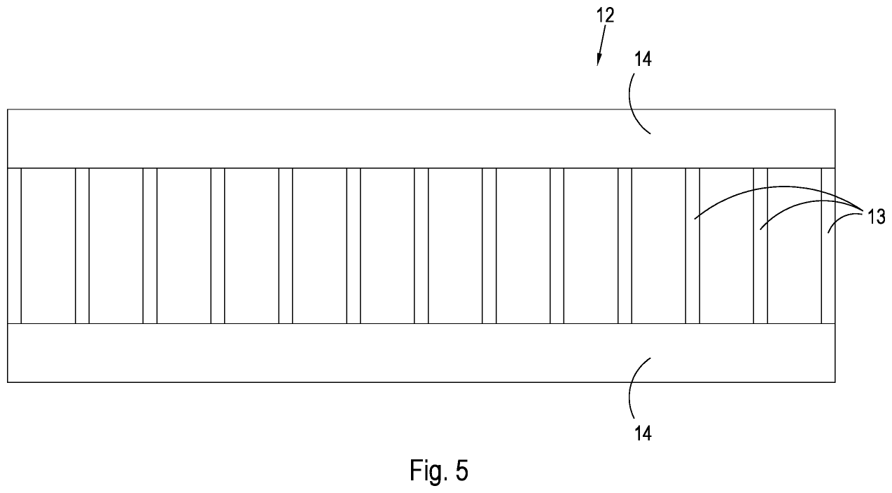

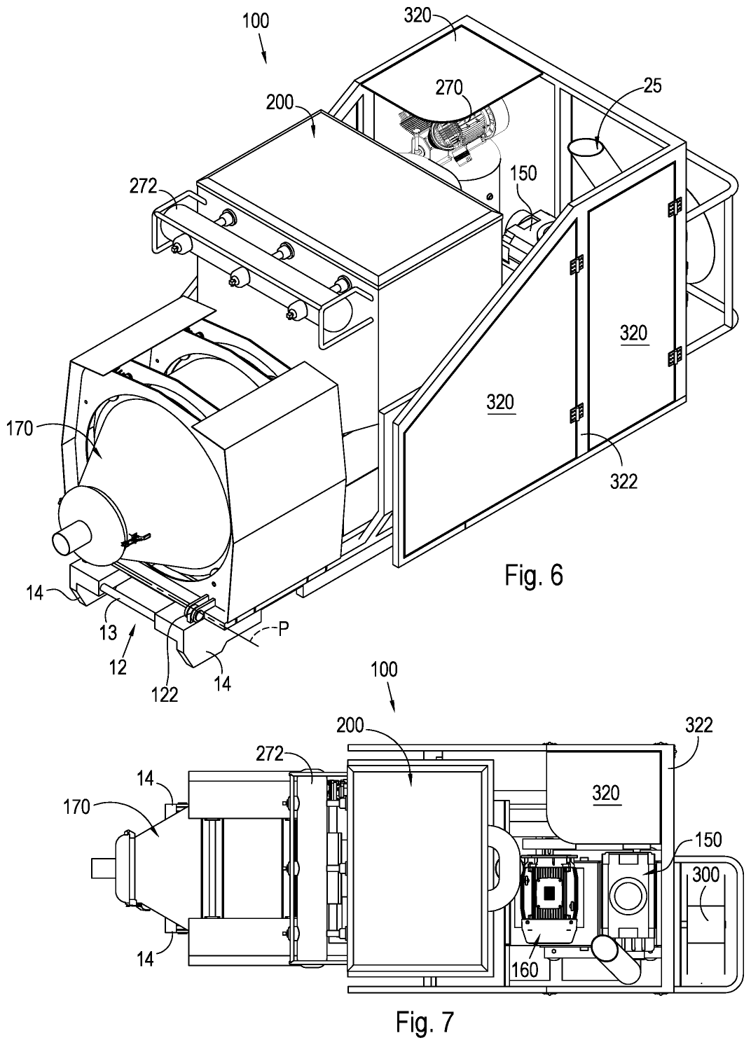

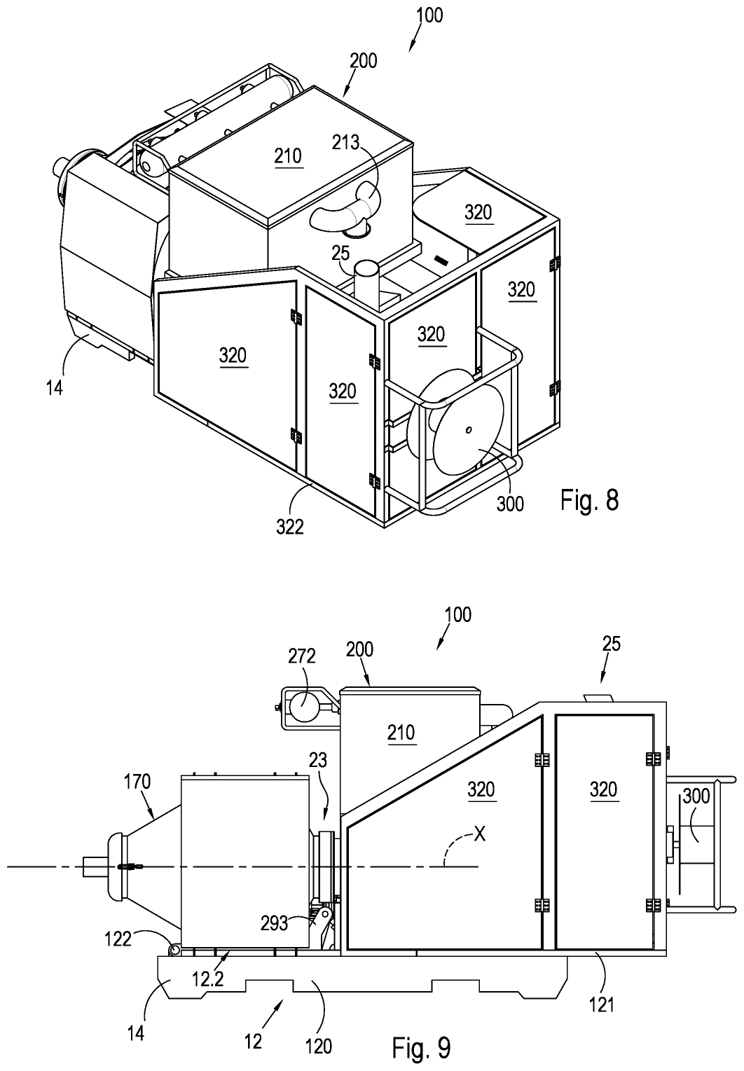

In the Figures, two embodiments of a particle extractor assembly in accordance with the invention have been illustrated. Although it is not limited to this application, the embodiments of the particle extractor assembly find application in the mining sector and are used to extract and collect dust and/or other airborne pollutants from a workface during, for example, drilling operations. Accordingly, the particle extractor assembly may be referred to as a vacuum dust extractor or collector. In FIGS. 1 to 4, reference numeral 10 designates a first embodiment of the particle extractor assembly and reference numeral 100 designates a second, preferred embodiment of the particle extractor assembly in FIGS. 6 to 16.

The particle extractor assembly 10, 100 is portable and can be transported to different locations as required. To this end, the particle extractor assembly 10, 100 includes a base 12 which is configured to be transported by a mining vehicle (not shown). The base 12 includes a skid which includes a pair of longitudinally extending, laterally spaced apart supports 14 which are interconnected by a plurality of spaced apart lateral struts 13. A lower profile of the base 12 corresponds to, and renders it transportable by, the mining vehicle.

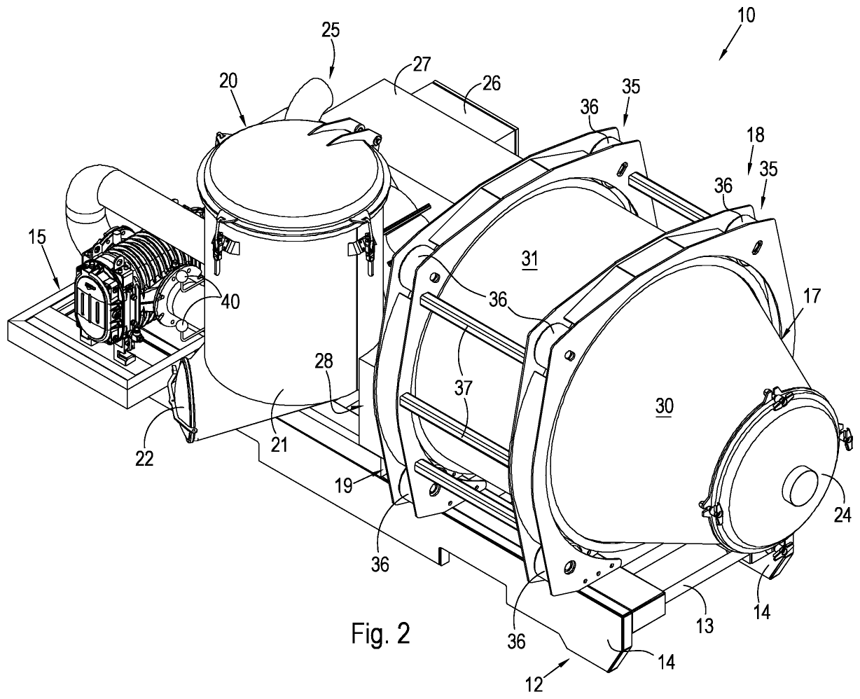

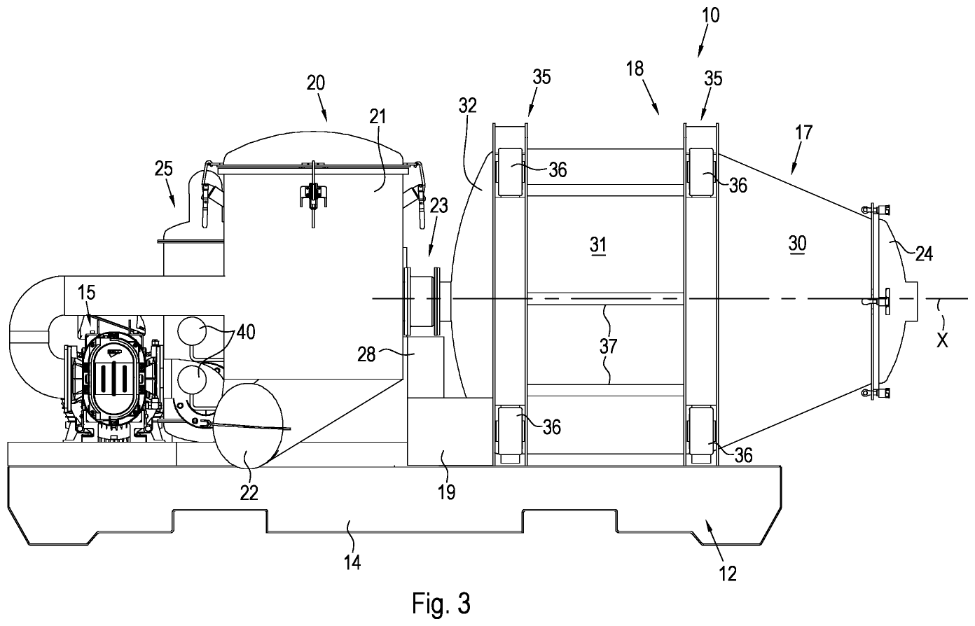

Referring specifically to FIGS. 1 to 4, the particle extractor assembly 10 further includes a centrifugal vacuum pump 15 (see FIGS. 2 and 3), and a powerplant in the form of an electrical motor 16 which is drivingly connected to the vacuum pump 15 by way of a flexible coupling. The particle extractor assembly 10 further includes a drum arrangement which includes a large hollow collector drum 17, a drum mounting 18 which is operatively connected to the base 12 and is configured to receive the collector drum 17 for rotation about a rotation axis X, and a drum drive 19 which is drivingly connected to the collector drum 17 and is configured to rotate the collector drum 17 relative to the base 12 and the drum mounting 18 about its substantially horizontal rotation axis X, in any one of two opposite directions. The drum drive 19 is configured to rotate the collector drum 17 in first and second directions relative to the drum mounting 18. In the first (anti-clockwise) direction, rotation of the collector drum 17 results in mixing of the contents of the collector drum 17. In the second (clockwise) direction, the collector drum 17 is configured to discharge its contents via an inlet. The drum drive 19 may include an electrical motor and an associated gearbox which is drivingly connected to the collector drum 17.

The collector drum 17 includes an inlet, closed by an inlet cover 24, which leads into an inner cavity and an outlet which leads from the inner cavity in a downstream direction. The inlet and outlet may be coaxially aligned and may line within a substantially horizontal plane.

The first embodiment of the particle extractor assembly 10 further includes a particle filter 20 which is configured to filter out harmful, oversized particles upstream of the vacuum pump 15 in order to prevent such particles from damaging the vacuum pump 15. The particle filter 20 includes a metallic filter housing 21 which houses a plurality of filter bags or socks (not shown). The filter housing 21 has a downwardly orientated inspection or discharge opening which is operatively closed by an inspection lid 22. By way of suitable piping, which includes a swivel joint 23 (see FIG. 3) disposed toward the outlet of the collector drum 17 to facilitate rotation of the collector drum 17 relative to the piping and other components, the collector drum 17 is connected in fluid flow communication with the downstream particle filter 20, and, in turn, the particle filter 20 is connected in fluid flow communication to the downstream vacuum pump 15. On the downstream side of the vacuum pump 15, clean filtered air is vented to atmosphere via an upright muffled exhaust 25.

The particle extractor assembly 10 further includes a control panel 26 which includes an electronic control unit (not shown). The control panel 26 provides an interface through which an operator can control the various components of the particle extractor assembly 10 by switching them on/off. Furthermore, the particle extractor assembly 10 is provided with emergency cut-out switches which can be used to interrupt operation of the vacuum pump 15, drum drive 19 and/or electrical motor 16. In addition, the assembly includes a pressurised air supply in the form of a compressor 27 which is configured to clean the filter bags of the particle filter 20 by intermittently pulsating the bags housed within the filter housing 21 with pressurised air. To this end, suitable hoses run from the compressor 27 to an inside of the filter housing 21. An adjustable pulse interval may be set to between 30 and 60 seconds or as otherwise desired. This interval is adjustable by the operator to suit the material being vacuumed.

The particle extractor assembly 10 further includes a tank 28 for holding an additive for mixing with the contents of the collector drum 17 to create a slurry or paste which can be effectively discharged. The additive mixes and binds with dust particles to form the slurry. This fluidised form of the vacuumed material is easier to handle and discharge, thus lowering contamination and pollution. To this end, the particle extractor assembly 10 includes an additive delivery system which is configured to introduce additive from the tank 28 into the inner cavity of the collector drum 17. The additive delivery system includes a dosing or delivery pump which is configured to pump additive from the tank 28 to the inner cavity of the collector drum 17 via a connection made between the tank 28 and the collector drum 17 at the swivel joint 23.

The collector drum 17 includes an operatively upstream frusto-conical portion 30, a narrow end of which defines the inlet and is shaped to receive the inlet cover 24. The frusto-conical portion 30 is connected to a downstream circular cylindrical portion 31 which, in turn, is connected to a convexly curved downstream end portion 32 which defines the outlet which is operatively connected to the swivel joint 23. An elongate vacuum pipe or hose (not shown) is operatively connected to the inlet cover 24 and sucks particles into the collector drum 17. The drum mounting 18 includes a pair of peripherally extending, longitudinally spaced apart braces or cradles 35 which at least partially wrap around the collector drum 17 and are configured to receive the collector drum 17. The cradles 35 are C-shaped and are mounted to the base 12. The cradles 35 are interconnected by way of peripherally spaced apart, elongate braces 37. Each cradle 35 includes four, peripherally spaced apart rollers 36, mounted between opposing flanges of the cradle 35, which facilitate rotation of the collector drum 17 relative to the drum mounting 18. The drum drive 19 is configured to rotate the collector drum 17 in clockwise and anticlockwise directions relative to the base 12.

In use, the particle extractor assembly 10 is transported to an above ground or underground workface. Once in place, the vacuum hose is correctly positioned in relation to the drill (not shown) in order to extract debris and dust as the drill operates. It will be appreciated that the vacuum hose may be connected directly to a drill boom or arm of a drill rig to collect particles at the workface.

Once all the precautionary safety measures have been taken, the electric motor 16 and vacuum pump 15 are turned on. The vacuum pump 15 creates suction and draws dust and other particles into the collector drum 17 via the hose and inlet. At this stage the collector drum 17 is stationary and does not rotate. Entrained finer or lighter particles will pass through the drum 17 via the outlet and into the particle filter 20 before the air passes through the vacuum pump 15 and is exhausted via the muffled exhaust 25. The particle extractor assembly 10 includes one or more load sensors (not shown) which are configured to sense a load of the collector drum 17. The load sensors may be coupled to the electronic control unit which is configured automatically to interrupt operation of the motor 16 and vacuum pump 15 once the control unit has established via the load sensors that the collector drum 17 has reached its maximum load or capacity. A load indicator e.g. a red light, gauge, dial or buzzer, may serve to indicate to the operator that the collector drum 17 has reached capacity. Whilst the vacuum pump 15 is running, the air compressor 27 intermittently cleans the filter bags of the particle filter 20 by pulsating the bags with pressurised air. Accordingly, the filter bags are cleaned, in situ, by way of air pulses. This method of cleaning is referred to as pulse jet cleaning. The particle extractor assembly 10 includes a pair of pressure sensors 40 configured to measure a pressure differential across the particle filter 20 in order to determine when the particle filter 20 needs to be cleaned/emptied via the inspection opening or otherwise maintained. The pressure sensors 40 are arranged across an inlet and outlet of the particle filter 20 and are configured to measure the pressure difference across the inlet and outlet of the filter 20.

Once the collector drum 17 is full, the vacuum pump 15 and motor 16 are turned off and the mining vehicle transporting the assembly 10 may be driven to an appropriate dumping site. In addition, the drum drive motor 19 is started and the collector drum 17 is rotated relative to the base 12 and drum mounting 18 in an anti-clockwise direction about the rotation axis X. At the same time, the dosage or delivery pump is started in order to introduce the additive into the inner cavity of the collector drum 17. Due to rotation of the collector drum 17, the contents of the drum 17 mixes with the additive and forms a slurry or paste. Once an adequate amount of additive has been introduced and mixed with the drum contents, the delivery pump is turned off.

Once the vehicle has reached the dumping site, the drum drive motor 19 is stopped and rotation of the collector drum 17 is reversed, i.e. it is rotated in a clockwise direction by operating the drum drive motor 19 in reverse in order to discharge the slurry from the collector drum 17 via the inlet. This necessitates prior removal of the inlet cover 24 or connection of a discharge hose. The same hose used for vacuuming may also be used for discharging. Angled vanes inside the collector drum 17 facilitate expulsion of the slurry from the inner cavity via the inlet, when the drum 17 is rotated in a clockwise direction. Once the slurry has been dumped, vacuuming can be restarted.

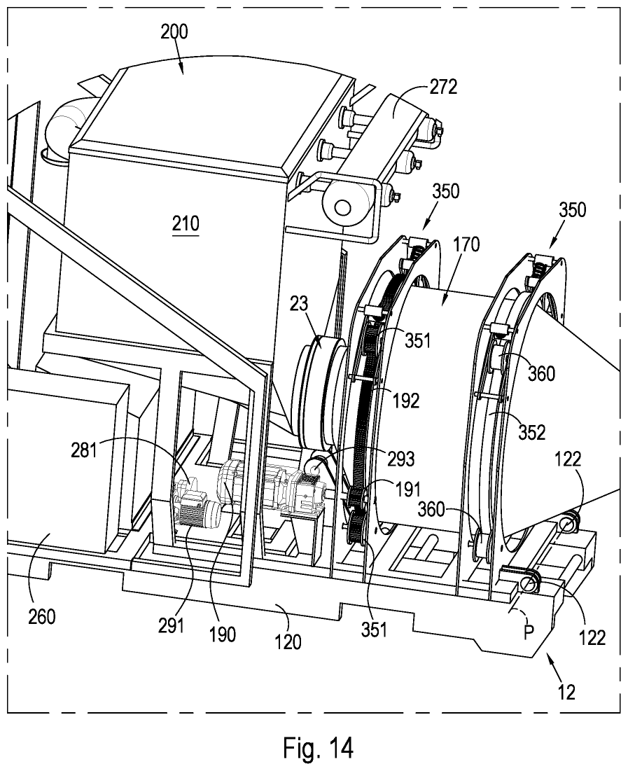

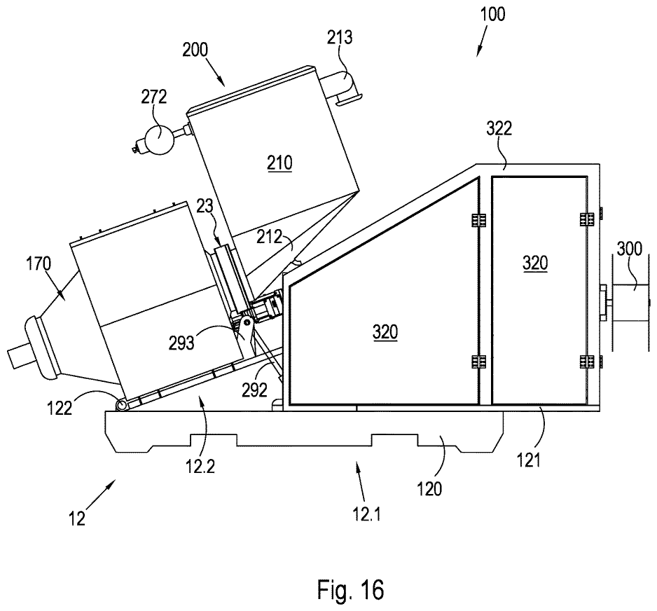

The second, preferred embodiment of the particle extractor assembly 100 is shown in FIGS. 6 to 16. The same reference numerals used above have again been used to refer to similar parts of the second embodiment. In principle, operation of the second embodiment is similar to the first embodiment. However, a number of design changes, which will be elaborated on below, have been introduced to improve performance of the second embodiment of the particle extractor assembly 100 when compared to the first embodiment. Referring now to FIG. 16, in particular, the base 12 of the second embodiment of the particle extractor assembly 100 includes a first stationary platform 12.1 which includes the skid 120 and a sub-frame 121 mounted to the skid 120, and a second pivot platform 12.2 which is articulated to the first stationary platform 12.1, by way of a pair of laterally spaced apart hinges 122 arranged toward a front end of the skid 120, for pivotal displacement relative to the first stationary platform 12.1 about a transverse pivot axis P (see FIGS. 6 and 14).

Similar to the first embodiment, the second embodiment of the particle extractor assembly 100 also includes a vacuum pump 150 mounted to the first stationary platform 12.1 of the base 12, and a powerplant in the form of an electrical motor 160 also mounted to the first stationary platform 12.1 adjacent to the vacuum pump 150. The electrical motor 160 is drivingly connected to the vacuum pump 150 by way of a drive belt and pulley arrangement. The particle extractor assembly 100 further includes a drum arrangement which includes a generally circular cylindrical collector drum 170 having an inlet for drawing particles into an hollow inner cavity of the collector drum 170 and an outlet leading to a particle filter 200. The drum arrangement further includes a drum mounting which is connected to the second pivot platform 12.2 of the base 12 and is configured to receive and support the collector drum 170 and a drum drive drivingly connected to the collector drum 170 and configured to rotate the collector drum 170 relative to the drum mounting about a rotation axis X (see FIGS. 9 and 11). The particle filter 200 is arranged upstream of the vacuum pump 150 in order to filter out particles upstream of the vacuum pump 150. However, the particle filter 200 is mounted to the second pivot platform 12.2 and is configured for pivotal displacement relative to the first stationary platform 12.1 about the pivot axis P, together with the drum arrangement, as can be seen in FIG. 16.

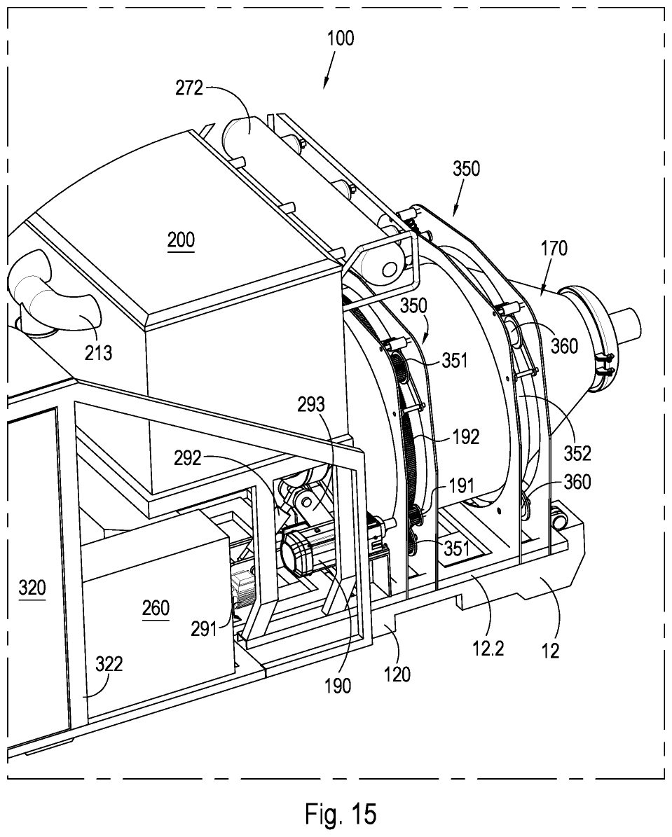

Referring to FIGS. 11 to 15, the drum mounting includes a pair of longitudinally spaced apart annular cradles 350 which extend at least partially around a periphery of the collector drum 170 and are configured to support and receive the collector drum 170. Referring specifically to FIGS. 14 and 15, one cradle 350 of the pair includes the drum drive which includes an electrical drum drive motor 190 which has a solid shaft connected to a drive gear 191 which drivingly engages a peripheral ring gear 192 of the collector drum 170. This cradle 350 includes a plurality of idler gears 351 which also engage the ring gear 192 at peripherally spaced apart positions. The other cradle 350 of the pair includes a plurality of idler rollers 360 which engage a peripheral collar 352 of the collector drum 170. The drum drive motor 190 and drive and idlers gears 191. 351 and rollers 360 together facilitate rotation of the collector drum 170 relative to the cradles 350 about the rotation axis X.

The particle extractor assembly 100 also includes an additive delivery system which includes a stainless-steel tank 280 for holding a water/additive solution. The tank 280 is mounted to the first stationary platform 12.1 of the base 12. The additive delivery system further includes a delivery pump 281 (see FIG. 14) which is configured to pump the additive from the tank 280 into the inner cavity of the collector drum 170, via a line which leads into the inner cavity, in order to form a slurry with particles sucked into the inner cavity by the vacuum pump 150.

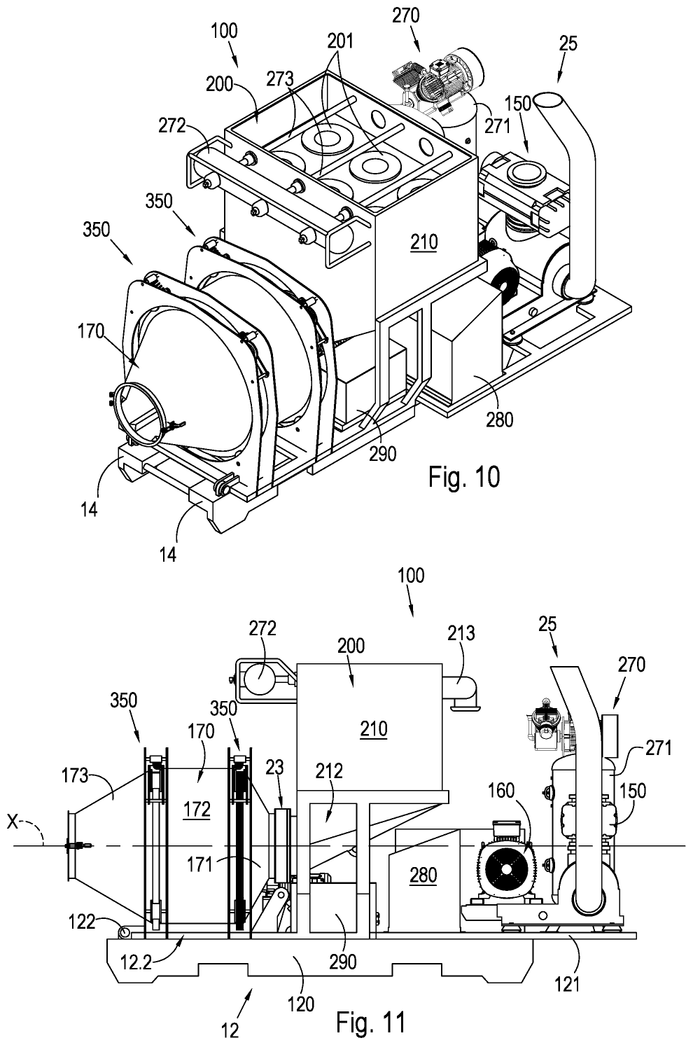

As can best be seen in FIGS. 15 and 16, the particle extractor assembly 100 includes an actuator operatively connected between the first stationary platform 12.1 and the second pivot platform 12.2. The actuator is configured pivotally to displace the second pivot platform 12.2 relative to the first stationary platform 12.1 about the pivot axis P which is transverse to the rotation axis X of the collector drum 170 between a lowered position shown in FIGS. 6 to 15 in which the second pivot platform 12.2 abuts the first stationary platform 12.1 and is coplanar therewith and a discharge position, shown in FIG. 16, in which the second pivot platform 12.2 is inclined with respect to the first stationary platform 12.1. The actuator includes a hydraulic fluid reservoir 290 (see FIGS. 10 and 11) and an electric motor and hydraulic pump 291 (see FIGS. 13 to 15) which are mounted to the first stationary platform 12.1 and a telescopically extendable hydraulic cylinder 292 which is operatively connected between the first stationary platform 12.1 and a clevis 293 protruding upwardly from a rear of the second pivot platform 12.2. The hydraulic pump 291 is configured to actuate the hydraulic cylinder 292 to displace the second pivot platform 12.2 between its lowered and discharge positions.

As can be seen in FIG. 16, when the hydraulic cylinder 292 is telescopically extended by the hydraulic pump 291, it lifts the rear end of the second pivot platform 12.2 including the drum arrangement and particle filter 200 such that the outlet of the collector drum 170 is raised with respect to the inlet to facilitate discharge of the slurry held in the inner cavity of the collector drum 170 from the collector drum 170 via the inlet.

As in the first embodiment, the drum drive motor 190 is configured to rotate the collector drum 170 about its rotation axis X in opposite, first and second directions. When the collector drum 170 is rotated relative to the base 12 in the first direction, the collector drum is configured to mix contents of the collector drum, and, when rotated about its rotation axis X in the second direction, the collector drum 170 is configured to discharge or expel its contents from the inner cavity via the inlet. The collector drum 170 also includes a plurality of internal vanes which are arranged to assist discharging of the contents from the collector drum 170 when rotated in the second direction.

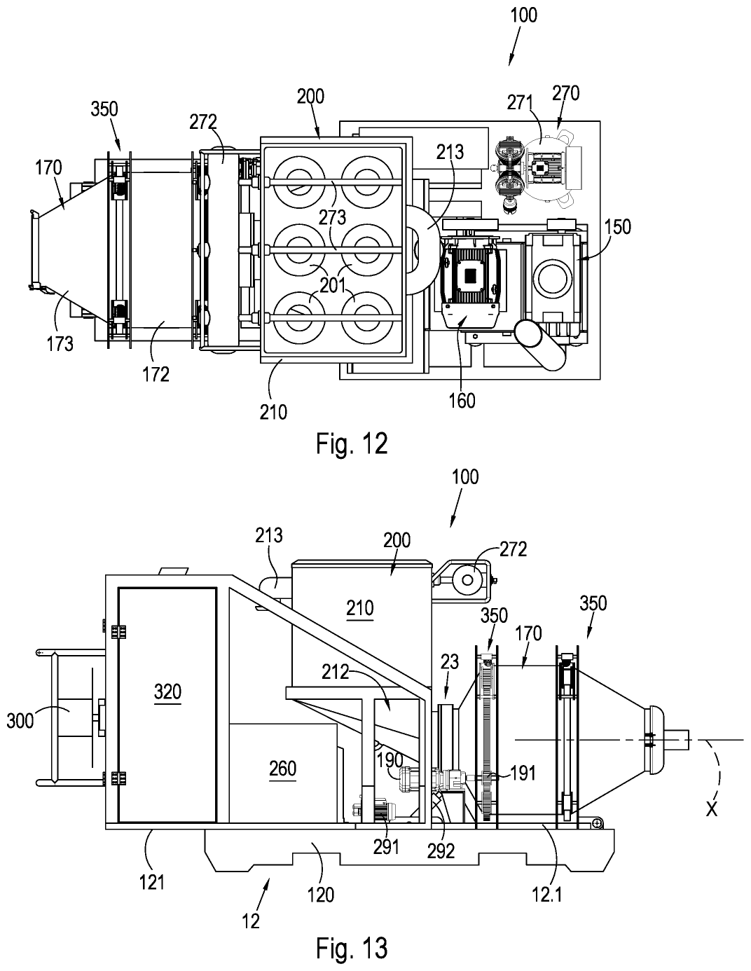

The particle filter 200 includes a plurality of filter bags 201 (see FIGS. 10 and 12) which are housed within a box-shaped filter housing 210 at a higher elevation than the outlet of the collector drum 170. The filter housing 210 includes a downwardly depending hopper 212 which is continuously connected to an upper part of the box-shaped filter housing 210 and is connected in fluid flow communication to the outlet of the collector drum 170 via swivel joint 23. The particle extractor assembly 100 further includes a pressurised air supply in the form of a compressor 270 having a primary/master pressure vessel 271 and a secondary/slave pressure vessel 272 for temporarily storing compressed air. The compressed air of the compressor 270 is used to clean the filter bags 201 of the particle filter 200, intermittently, by pulsating air through the filter bags 201, in reverse, thus serving to dislodge particles potentially clogging the filter bags 201 and ejecting the dislodged particles back into the collector drum 170 via the hopper 212 and outlet of the collector drum 170 arranged below the filter bags 201. The slave pressure vessel 272 is connected to nozzles via air tubes 273 and is configured to pulsate air through the filter bags 201. On the downstream side of the vacuum pump 150, clean filtered air is vented to atmosphere via an upright muffled exhaust 25.

Referring now to FIGS. 11 and 12, the collector drum 170 includes a downstream portion 171 which tapers toward the outlet, a circular cylindrical portion 172 connected to the downstream portion 171, and a frusto-conical portion 173 which is connected to the circular cylindrical portion 172. The frusto-conical portion 173 tapers to the operative upstream inlet of the collector drum 170. The collector drum 170 also includes a removable lid which is configured to close the inlet, at least in part. To facilitate easy discharge of the slurry and to prevent setting and binding thereof with an inner surface of the collector drum 170, the inner surface of the collector drum 170 has a non-stick coating.

The particle extractor assembly 100 includes an electrical control panel 260 mounted to the first stationary platform 12.1. An electronic control unit is housed within the electrical control panel 260. An operator interface (not shown) is provided for controlling the particle extractor assembly 100. By way of one or more load sensors (not shown) which are coupled to or communicatively linked to the electronic control unit, operation of the vacuum pump 150 may be interrupted if the load sensors indicate that the collector drum 170 is overloaded. The electrical control panel 260 includes a load indicator which is configured to indicate an overload condition to an operator.

The particle extractor assembly 100 includes a plurality of planar protective panels 320, some of which are hingedly mounted to a frame 322 which, in turn, is mounted to an outer periphery of the first stationary platform 12.1 of the base 12. The protective panels 320 and frame 322 guard an operator or other workers from harm by at least partially enclosing moving or hazardous parts of the particle extractor assembly 100. A flexible and extendable concertina hose (not shown) connects a T-piece 213, depending from the particle filter 200, in fluid flow communication with the vacuum pump 150 to complete a suction line passing through the assembly 100. An electrical cable reel 300 holds an electrical cable which is used to feed electrical power to the 45 kW electrical motor 160. The cable reel 300 is mounted to a rear of the frame 322 of the assembly 100. Although this has not been clearly illustrated, the electrical cable reel 300 may be configured to pivot relative to the frame 322 between a stowed position and an operative reeling-in position to facilitate reeling of an electrical cable on the reel 300 using a manual crank spanner which attaches to the reel 300. The drum mounting also includes protective panels which partially enclose the collector drum 170, cradles 350 and drum drive motor 190.

The second embodiment of the particle extractor assembly 100 has the following advantages over the first embodiment when compared to the first embodiment. First, introduction of the actuator including the hydraulic cylinder 292 which is configured pivotally to displace the second pivot platform 12.2 holding the collector drum 170 and particle filter 200 between its lowered and discharge positions, ensures that at least a majority portion of the slurry held in the inner cavity is discharged or ejected therefrom despite the fact that the assembly 100 may not necessarily be positioned on a level surface. Secondly, second handling of ejected dust particles dislodged from the filter bags is obviated by reintroduction of the ejected particles into the collector drum 170 via the hopper 212. In the first embodiment of the particle extractor assembly 10, the dislodged particles where ejected via the inspection opening covered by the removable inspection lid 22 which necessitated second handling of those particles. Furthermore, the introduction of the slave pressure vessel 272 obviates regular start-ups of the compressor 270 to repressurise a pressure vessel each time pressure is reduced due to pulsation of air through the filter bags. Recurring start-ups shorten the life of the compressor 270. In the master/slave configuration, the compressor 270 only needs to start-up once pressure in the slave pressure vessel has drop below a predetermined threshold. Air in the larger master pressure vessel is then transferred to the slave pressure vessel to repressurise it and the compressor 270 only starts-up then to repressurise the master pressure vessel. Previously, the compressor 270 started-up more frequently as pressure in the single pressure vessel dropped.

The Applicant believes that the particle extractor assembly 10, 100 in accordance with the invention provides an effective solution for overcoming dust pollution issues by implementing dust suppression, collection, handling and ejection. Instead of venting harmful pollutants to atmosphere, the assembly 10, 100 is configured effectively to remove such particles from the air at source thereby preserving the environment and protecting employees from health hazards associated with breathing in polluted air. It is to be appreciated that the particle extractor assembly may be connected directed to a drill arm of a drill rig to extractor air pollutants at the source. Control of the particle extractor assembly may also be integrated with a control interface of the drill rig.

1. A particle extractor assembly which includes:
a base;
a vacuum pump mounted to the base;
a powerplant mounted to the base, the powerplant being drivingly connected to the vacuum pump;
a particle filter arranged upstream of the vacuum pump in order to filter out particles upstream of the vacuum pump;
a drum arrangement which includes:
a collector drum having an inlet for drawing particles into an inner cavity of the collector drum and an outlet leading to the particle filter;
a drum mounting which is operatively connected to the base and is configured to receive the collector drum; and
a drum drive drivingly connected to the collector drum and configured to rotate the collector drum relative to the drum mounting about a rotation axis; and
an additive delivery system which is mounted to the base and which includes a tank for holding an additive, the additive delivery system being configured to introduce additive from the tank into the inner cavity of the collector drum, wherein the vacuum pump is configured to create suction through the particle extractor assembly to draw particles into the collector drum via the inlet, the collector drum being configured, upon rotation of the collector drum about its rotation axis, to mix the additive introduced into the inner cavity by the additive delivery system with the particles in the inner cavity of the collector drum to form a slurry.

2. A particle assembly as claimed in claim 1, which is configured, upon rotation of the collector drum about its rotation axis, to discharge the slurry from the inner cavity of the collector drum.

3. A particle extractor assembly as claimed in claim 2, wherein the base includes a first platform and a pivot platform, the pivot platform being articulated to the first platform, and wherein the particle extractor assembly includes an actuator operatively connected between the first platform and the pivot platform, the actuator being configured pivotally to displace the pivot platform relative to the first platform about a pivot axis which is transverse to the rotation axis of the collector drum between a lowered position in which the pivot platform abuts the first platform and is coplanar therewith and a discharge position in which the pivot platform is inclined with respect to the first platform.

4. A particle extractor assembly as claimed in claim 3, wherein the drum arrangement and the particle filter are mounted to the pivot platform and are configured for pivotal displacement therewith about the pivot axis and wherein the actuator includes a hydraulic pump which is mounted to the first platform and a hydraulic cylinder which is connected between the first platform and the pivot platform, the hydraulic pump being configured to actuate the hydraulic cylinder to displace the pivot platform between its lowered and discharge positions.

5. A particle extractor assembly as claimed in claim 4, wherein, when the pivot platform is in its discharge position, an operatively downstream end of the collector drum defining the outlet is raised with respect to the inlet of the collector drum to facilitate discharge of the slurry held in the inner cavity of the collector drum from the collector drum via the inlet.

6. A particle extractor assembly as claimed in claim 1, wherein the drum drive is configured to rotate the collector drum about its rotation axis in opposite, first and second directions, wherein, when the collector drum is rotated relative to the base in the first direction, the collector drum is configured to mix contents of the collector drum, and, when rotated about its rotation axis in the second direction, the collector drum is configured to discharge or expel its contents from the inner cavity via the inlet, the collector drum including a plurality of internal vanes which are arranged to assist discharging of the contents from the collector drum when rotated in the second direction.

7. A particle extractor assembly as claimed in claim 1, wherein the particle filter is arranged downstream of the collector drum and upstream of the vacuum pump, the particle filter including a plurality of filter bags which are housed within a filter housing at a higher elevation than the outlet of the collector drum, the filter housing including a downwardly depending hopper which is connected in fluid flow communication to the outlet of the collector drum.

8. A particle extractor assembly as claimed in claim 7, which includes a pressurised air supply which is configured to clean the filter bags of the particle filter, intermittently, by pulsating air through the filter bags, in reverse, thus serving to dislodge particles potentially clogging the filter bags and ejecting the dislodged particles back into the collector drum via the hopper arranged below the filter bags.

9. A particle extractor assembly as claimed in claim 8, which includes a pair of pressure sensors arranged across an inlet and outlet of the particle filter and configured to measure a pressure differential across the particle filter in order to determine when the particle filter needs to be cleaned.

10. A particle extractor assembly as claimed in claim 8, wherein the pressurised air supply includes a compressor having a primary pressure vessel and a downstream secondary pressure vessel which is connected to nozzles configured to pulsate air through the filter bags.

11. A particle extractor assembly as claimed in claim 1, wherein the additive delivery system includes a delivery pump which is configured to pump additive from the tank to the inner cavity of the collector drum.

12. A particle extractor assembly as claimed in claim 1, wherein the drum mounting includes a pair of cradles which extend at least partially around a periphery of the collector drum and are configured to receive the drum, the cradles including rollers which facilitate rotation of the collector drum relative to the cradles, and wherein the collector drum includes a downstream portion toward the outlet, a cylindrical portion connected to the downstream portion, and a frusto-conical portion which is connected to the cylindrical portion and which tapers to the operative upstream inlet of the collector drum, the collector drum including a removable lid which is configured to close the inlet, at least in part and wherein an inner surface of the collector drum has a non-stick coating.

13. A particle extractor assembly as claimed in claim 1, which includes a silencer which is operatively in fluid flow communication with the vacuum pump, downstream of the vacuum pump and is configured to lower emission sounds of the particle extractor assembly to equal to, or below 80 dB, an exhaust of the particle extractor assembly being operatively upwardly orientated.

14. A particle extractor assembly as claimed in claim 1, which includes an electrical control panel and an electronic control unit which provide an operator interface for controlling the particle extractor assembly, and one or more load sensors which are coupled to or communicatively linked to the electronic control unit, wherein the electronic control unit is configured to interrupt operation of the vacuum pump if the load sensors indicate that the collector drum is overloaded, the electrical control panel including a load indicator which is configured to indicate an overload condition to an operator.

15. A particle extractor assembly as claimed in claim 1, which includes protective panels, mounted to the base, which guard, by at least partially enclosing, an operator from components of the particle extractor assembly, and wherein the particle extractor assembly is portable.

16. A method of collecting dust and/or other airborne particles using a particle extractor assembly as claimed in claim 1, the method including:
collecting airborne particles in the collector drum of the particle extractor assembly by operating the vacuum pump to create suction through the particle extractor assembly;
treating contents of the collector drum using an additive by delivering the additive to the collector drum to form a slurry; and
discharging the contents from the collector drum.

17. A method as claimed in claim 16, wherein collecting includes, intermittently cleaning the particle filter by pulsating filter bags of the particle filter with pressurised air.

18. A method as claimed in claim 17, wherein collecting includes sensing, using a least two pressure sensors, a pressure differential across the particle filter in order to determine when the particle filter needs to be cleaned.

19. A method as claimed in claim 16, wherein treating includes rotating the collector drum relative to the base of the particle extractor assembly in a first direction in order to mix the contents.

20. A method as claimed in claim 19, wherein discharging includes rotating the collector drum relative to the base in a second direction opposite to the first direction and pivotally displacing a pivotal platform of the base to a discharge position in which it is inclined with respect to a remainder of the base.
